(19) United States
(12) Patent Application Publication
(10) Pub. No.: US 2008/0172926 A1
(43) Pub. Date: Jul. 24, 2008

(54) Dual, inline, single action rat trap

(76) Inventor: David Wayne Wright, San Francisco, CA (US)

Correspondence Address: DAVID WAYNE WRIGHT, 955 CAROLINA STREET, SAN FRANCISCO, CA, 94107, US

(21) Appl. No.: 11/656,356

(22) Filed: Jan. 23, 2007

(51) Int. Cl. A01M 23/30

(52) U.S. Cl. 43/81

(57) ABSTRACT

One embodiment of a rat/mouse trap, reconfigured to increase efficiency of take down rates, utilizing two inline and opposing alloy bows (10) mounted on an elongated wooden platform or the main body (20). Mounting holes (18) one in each of the four corners, pre-drilled for ease of horizontal or vertical mounting. The opposing and inline bows (10) are rectangular in shape, comprised of sturdy alloy; two hold down rods (14), also comprised of a suitable alloy; two adjacent bait pedals (12), comprised of a material sturdy enough to hold rod in place and two tension springs (28), all of which are either adjacent or opposing. The trap is armed by pulling the bow (10) into the locking position with one hand and holding the bow (10) in place with the thumb while extending the hold down rod (14) over the bow (10) and placing the free angled end under the bait pedal (12) engagement surface, toward centerline (32) on the main body (20). This action is repeated on the opposite side. The efficiency in take down rate is attributed to a dual bow releasing snapping action, at or near simultaneous, and its own stability.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of the Invention

This invention relates to small animal traps of the type that generally are used for individual trapping of large and small rodents.

2. Prior Art

This invention relates to animal traps and methods for using same.

Numerous types of single action, single bow and single throw; bait pedal and trigger mechanisms of this type have been used in the past. Pest control professionals have used them all, with limited results. The conventional single bow, single catch rattrap includes a bow, a bait pedal and a single hold down rod.

Prior art, for example, U.S. Pat. No. 4,245,423 Souza et al. Jan. 20, 1981 contains single bow, single pedal, stand alone, small animal traps, ineffective in that they are easily upended with rodent contact due to it's own instability; light weight and small in size,—an inherent design flaw—thus creating instability.

Other traps, essentially designed with the same idea in mind yet using different hardware, for example, U.S. Pat. No. 4,711,049 Kness et al. Dec. 8, 1987, U.S. Pat. No. 4,369,595 Kness et al. Jan. 25, 1983, and U.S. Pat. No. 4,297,805 also Kness et al. Nov. 3, 1981, to name a few, have not only replicated this stand alone, single action design but have created a re-design that is essentially cost prohibitive for mass production.

Small, single bow traps of this type are prone to be hazardous to the operator's hands and fingers due to their small size and limited space for holding onto trap while in process of arming trap.

Single throw, single bow traps are also ineffective in that if the bow is prematurely released, it may simply scare rodent, possibly upend itself, definitely displace itself away from its desired position and thereby further prohibit future rodent contact with trap until it is manually replaced in the desired position.

These small, single bow, single throw are also ineffective in placement of rodent travel due to the design, which encourages placement perpendicular to the wall as opposed to parallel to the wall, bait pedals with bait applied facing wall or other solid structure, as opposed to parallel to and inline of rodent travel. Rodent travel may simply touch-off bait pedal and disrupt trap but not necessarily entrap rodent.

Single bow, single bait pedal, single catch also rely on the rodent being in one place long enough to make contact with bow, for example, U.S. Pat. No. 4,245,423 Souza et al. Jan. 20, 1981.

Sensitivity of single bow, single pedal may also be compromised in other ways, outside the realm of rodent contact. They may upend itself thru light human contact like during placement of trap in the horizontal position i.e. behind large commercial objects that are known for excessive rodent travel or physically displaced, also thru human contact or contact with moving object, although inadvertently, thereby also limiting its catch rate.

Single bow, single pedal, single catch are unable to effectively perform while in the vertical position due to the quick passing of rodent over surface of trap, regardless of direction, prematurely releasing bow but not facilitating take down of rodent.

Single bow, single bait pedal traps do not contain holes in each corner to allow vertical placement via strapping to standing pipes et al or able to stabilize horizontally to wooden rafters via metal fasteners. Therefore, small design and single throw nature are not conducive for placement along rodent travel. Single throw, single traps are designed to wait for rodent to stop, sniff, inspect and hopefully take bait, thereby springing trap.

### SUMMARY

The novel approach in reconfiguring an old product is to sufficiently elongate the base to provide stability in the vertical position while providing dual and opposing, yet identical hardware to increasing efficiency in take down rates, with or with out bait.

### DRAWINGS—FIGURES

FIG. 1 is the top view of the rattrap, with the bows in the set position, representing components that make up the whole,

FIG. 2 is a side view of rattrap, representing components horizontal to main body portion and in the armed position.

FIG. 3 is a side view of trap, depicting line of travel of bow members following contact with bait pedal resulting in disengagement of hold down rods.

FIG. 4 is an end view drawn in perspective (1 of 2)

### DRAWINGS—REFERENCE NUMERALS

10. bow
10a. bow(s) in sprung position
12. bait pedals
14. hold down rods
16. 30-45 degree reduction
18. mounting holes
20. main body
22. pivot points of hold down rods
24. bait box (liquid)
26. bait prongs (solid bait)
28. tension springs
30. bow pivot points
32. centerline

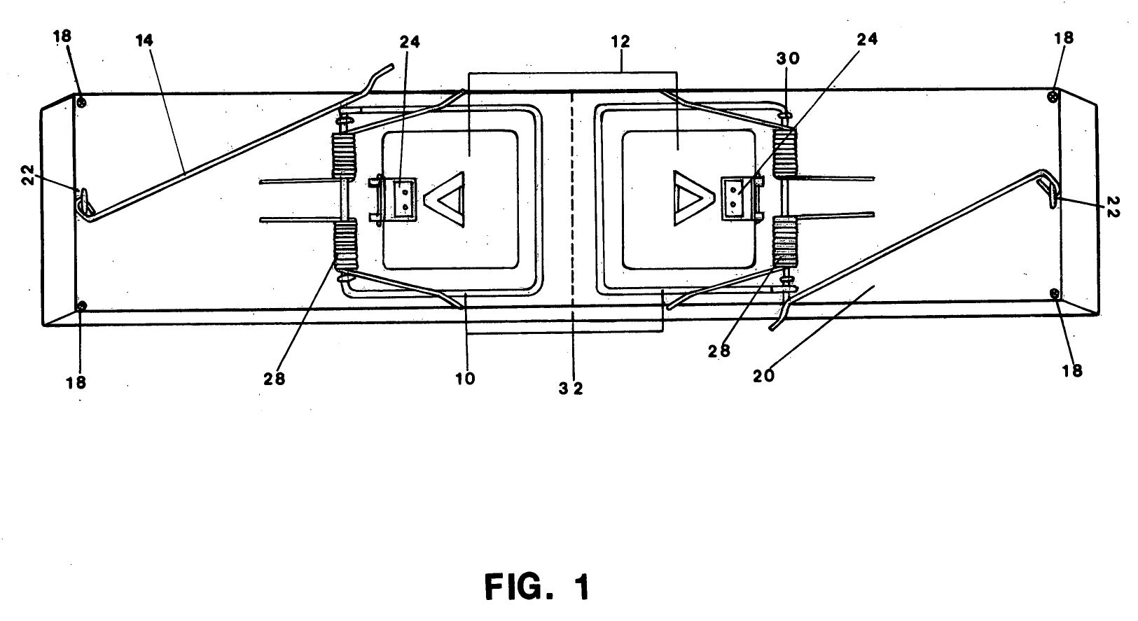

### DETAILED DESCRIPTION—FIG. 1-4—PREFERRED EMBODIMENT

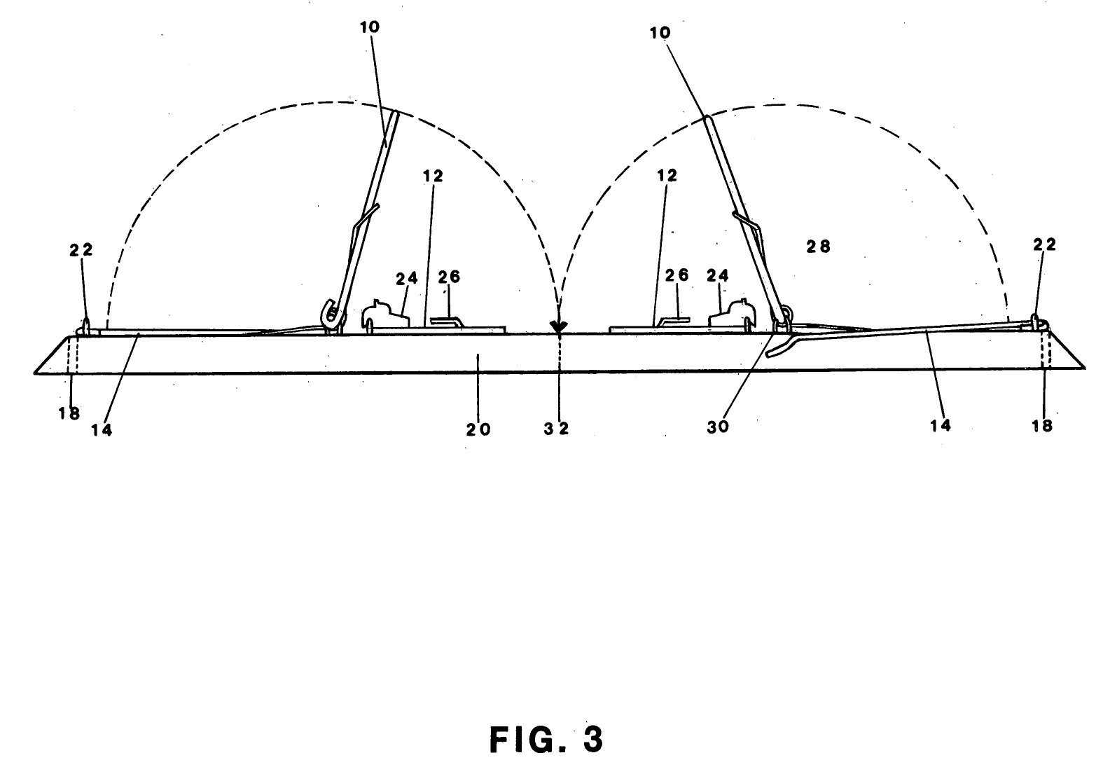

The preferred—but not limited to—embodiment of the dual, inline, single/double action rattrap is illustrated in FIG. 1 (top view) and FIG. 3, (side view). The dual inline, single/double action rattrap has a sufficiently elongated main body portion 20 measuring 8.5 cm×40-45 cm, over 2× the overall length of a single throw, single action trap. In this preferred embodiment, the main body 20 is comprised of wood supporting the FSC, an organization responsible for forest management but may be manufactured out of any recyclable material, as long as it is able to facilitate ease and inexpensive mounting of plastic and metal hardware.

With this preferred embodiment, the main body 20 consists of two adjacent bait pedals 12, both of which are placed to the right and left of centerline, adjacent to and facing each other but not touching, pivoting on individual pivot points. The bait pedals 12 are solid in form, square in shape, approx 5 cm×5 cm, creating individual surface area of approx. 25 cm per bait pedal or approx. 50 cm total, and are manufactured, as with this preferred embodiment, utilizing a plastic injection molding. As described in greater detail in the previous art, U.S. Pat. No. 4,245,423 Souza et al. Jan. 20, 1981, consists of an upward box section for liquid bait 24 and prongs 26 that are positioned to facilitate solid bait as well.

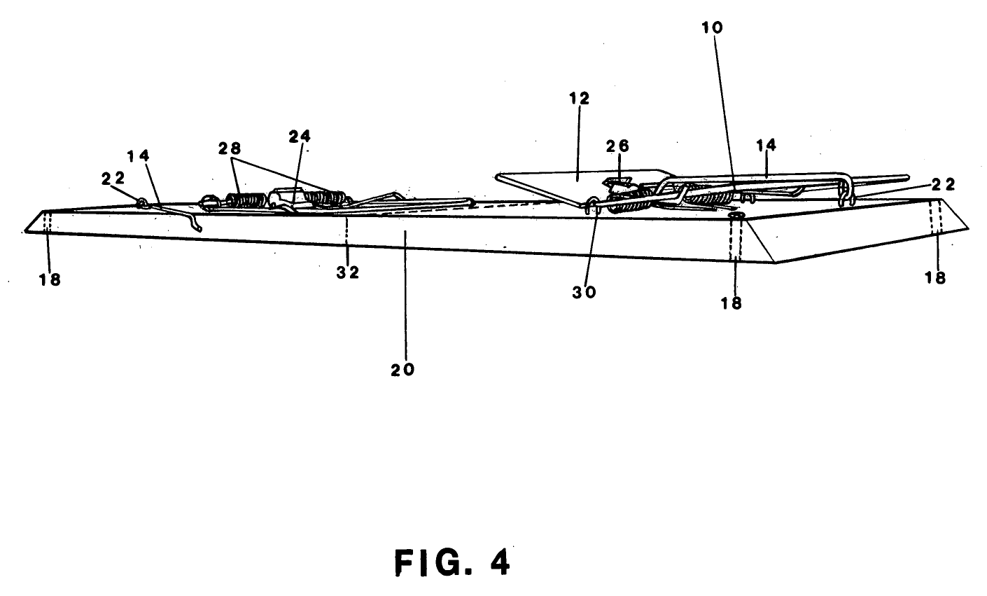

Two straight, inline and opposing hold down rods 14 as presented in this preferred embodiment, are approx. 10.8 cm inches long, angled at the free end, comprised of an inexpensive alloy that is also strong, secured on either end 22 (FIG. 4) of elongated main body 20, just on the upper edge of the 30-45 degree angle 16 centered, via looped, metal hold-down staples. One end of each hold down rod 14 is permanently mounted on its outer edge 22 and yet maintaining free ends that are able to pivot towards the centerline.

In this preferred embodiment, the bows 10 are tubular in design, roughly 2× the thickness of a standard coat hanger, forming a rectangular shape, measuring 8.5 cm×7 cm with a total containment area of approx. 59.5 cm and are manufactured of steel or other alloy for strength purposes. Each opposing bow end 10 in this preferred embodiment, is permanently fixed to main body 20 just to the rear of each bait pedal 12, fitted thru a tension spring 28 measuring approx. 5.5 cm in length with a 1.5 cm gap. The bows 10 are also fixed on either outer edge with looped, steel fasteners 30 creating a centralized pivot point. Each bow 10 is affixed on the rear side of adjacent bait pedals 12, away from centerline, and is able to surround the bait pedal 12 in the sprung position. The second and opposing bow 10 is placed opposite and facing first bow 10, also affixed behind its respective bait pedal 12 and also is able to surround its respective bait pedal 12 area in the sprung position. Both bows will be facing centerline 32 in the sprung position.

The tension springs 28 are affixed atop and transverse to main body 20 through opposing tension on either side of fixed portion of bow 10. Two legs of the tension springs 28 are held in place through downward force over bow 10 outer lengths and additional tension on inner portion with legs extending down and into main body portion 20 creating equal and opposing tension. Each tension spring 28 houses an approx. 7.2 cm length of bow 10 allowing that portion of bow 10 to remain affixed to body portion 20 yet able to pivot on a 180-degree horizontal axis, ending at centerline 32.

Four holes total 18, one in each corner of main body 20, just to the outside of hold down rod pivot points 22 allows for ease of affixing elongated body 20 in any vertical or horizontal position.

### Operation—FIGS. 1, 2, 3

The preferred manner of using this dual, inline, single action rattrap as presented in FIG. 1 (top view) is nearly identical to the operation of the more conventional and widely realized, single throw, single catch rattraps.

Namely, the bow 10 is set in the same way, utilizing operators thumb to hold bow 10 down, opposite of bait pedal 12 in strict opposition to tension spring 28 while taking the free hand and maneuvering the hold down rod 14 sufficiently under the engagement surface of bait pedal 12 allowing the hold down rod 14 to maintain bow pressure while in the set position, not enough to permanently hold bow 10 in place but just enough to allow the slightest vibration, mechanical or small animal contact to release the hold down rod 14 and allow the bow 10 to pivot from the armed position to the sprung position, while trap is perpendicular or parallel to baseboard of wall. Refer to U.S. Pat. No. 4,245,423 Souza et al Jan. 20, 1981 for a more detailed operation for this type of trap.

However, this single throw, single action rattrap relies on rodent being in one position long enough, in the exact position long enough, for sprung bow 10 to make contact and force rodent to the main body portion, thus effecting kill.

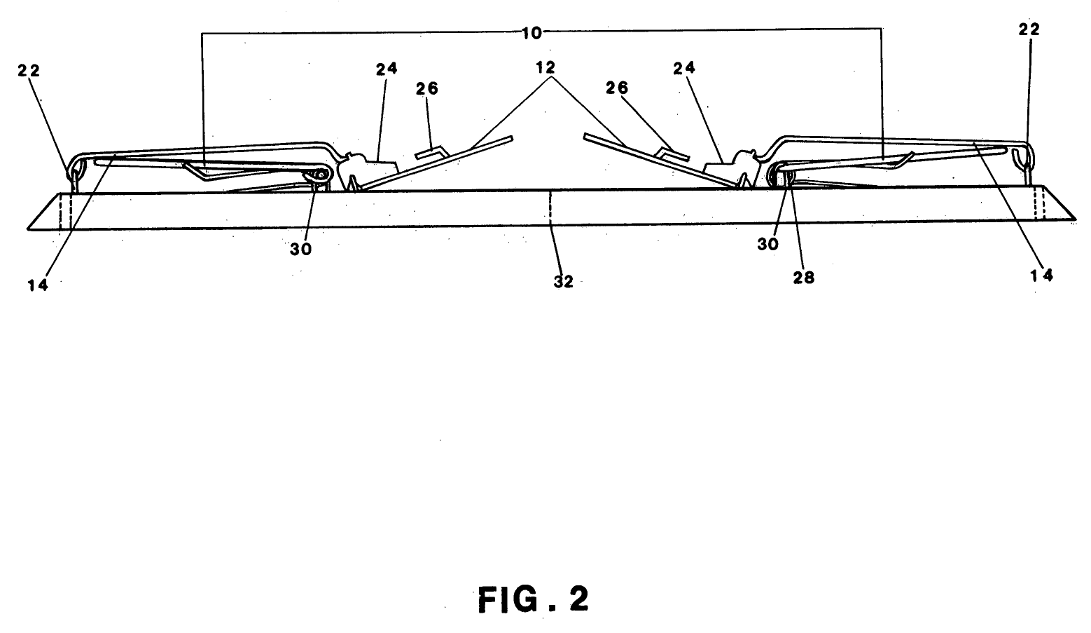

In this new configuration of on an old, widely utilized product, subtle but novel changes have been made whereby the main body 20 (FIGS. 1 and 2) has been sufficiently elongated to accommodate two bows 10 (FIGS. 1 and 2) opposing and facing each other; two bait pedals 12 and two hold down rods 14 (FIG. 1), opposing and in line, with opposite ends of main body 20 reduced to a 30-45 degree angle 16 (FIGS. 2 and 3) increasing guaranteed travel in a straight line over top of trap, thusly increasing catch and kill rate.

Contact with a bait pedal 12 by rodent passing over the trap in a generally straight line, to remove solid bait from prong 26 or just to travel from point A to point B, triggers the respective bait pedal 12 allowing the release of hold down rod 14, freeing the first bow 10 from it's temporary position, allowing the bow 10 to extend up and over rodent, in a 180 degree arc, striking animal from behind and forcing it to the main body portion at centerline 32.

The vibration caused by bow 10 striking the head or upper body area of rodent or other small animal, being transmitted down through it's body and directly to the baseboard 20 or by direct mechanical contact of the first bow 10 either by making contact with the rodent or simply hitting near the center line of trap, between adjacent bait pedals 12 triggers the release of the second opposing yet inline hold down rod 14 from it's position on the underside of the second bait pedal 12, allowing the respective bow 10, depending on direction of travel, to release, also in a 180 degree arc, over bait pedal 12 and over the head of rodent, to facilitate dual striking actions, which may occur as near separate actions or can occur as one simultaneous action, thus greatly increasing odds of kill as opposed to rodent escaping unscathed, fleeing a loud, unsecured and possibly upended trap.

Furthermore, this new redesign of an old product encapsulates four holes 18 one on each corner of the trap (FIG. 1) designed to allow strap-down means, be it twine, nylon straps or other similar yet sturdy strapping means to facilitate secure placement in the vertical or horizontal position, vertically along piping systems or placed horizontally along rafters et al. or in any place that has known rodent runs.

Placement of traps, as presented in (FIG. 1) is most advantageous if placed directly atop of and in line known travel runs, secured in the vertical position or secured flat on and overhead rodent run the with screws or other such metal fasteners or placed parallel to the wall yet directly in the path of known rodent travel.

Lastly, this new design, when used properly, may be used with bait attached to bait prongs 26 or, while in the horizontal position, with liquid bait in box-like receptacles 24. Better yet, it may also be utilized bait less, as the action will occur regardless of attractant applied to bait pedals.

### ADVANTAGES

Therefore, a primary object for overcoming the shortcomings of the before mentioned prior art, is a provision for an improved animal trap thereby increasing its stability and thusly, its takedown rate.

A further object of this present invention is to increase operator safety by increasing the size of main body portion, giving ample room for handling of trap during arming.

A further object of the present invention is the provision of an animal trap with two opposing striking bows, two adjacent bait pedals, two inline hold down rods, thereby increasing take-down rate, should the rodent simply try to pass over or across the bait pedal area.

A further object is to increase retention of small animal to baseboard with the configuration of opposing bows, both armed and able to secure rodent at centerline.

A further object of this invention is to approximately double the overall length of baseboard, supplying ample mounting area for all above stated hardware, while allowing ease of placement behind large commercial objects.

A further object of this present invention to place the hardware, i.e. bows opposing and facing each other, allowing bows to strike at or nearly simultaneously, from opposing sides, increasing take-down rates

A further object of this invention to place two bait pedals, adjacent to each other, increasing bait/bait less area to be contained by the striking bows.

A further object of present invention is getting away from accepted standards of practice of setting the trap perpendicular to wall and instead, a new configuration that allows placement of trap parallel to wall or in direct line of travel, thereby also increasing takedown rate.

A further object is to establish holes, one in each corner, to facilitate stabilizing trap in the vertical position, using either metal, nylon or twine strapping methods, allowing ease of arming trap, thereby preventing premature releasing of bows to movement, thus improving safety to operator.

A further object of this invention is to decrease man-hours needed to place two single action traps inline, thereby decreasing man-hours spent on commercial pest control accounts, trying to establish placement

It is also an object of this invention to reduce costs of manufacturing two traps but instead the manufacture of one trap with dual hardware components that are in current use and circulation. Thusly, due to its low manufacturing costs, allows the trap to be thrown into a waste receptacle without worrying about handling the fresh kill. The cost of replacing trap is considerably lower than the cost of damage created by one rodent.

A further object of this invention is to change the overall look of the traditional rattrap, thereby impressing future clients with its newness, design modifications and increased effectiveness.

A further object of this invention is to reduce opposing ends of elongated baseboard 30-45 degrees, manipulating rodent travel in a generally straight line, over the top surface of trap towards centerline, thus increasing take-down rate.

And lastly, an object of this invention is to retain its ease of use by operators skilled in the art of commercial and residential pest control.

### CONCLUSION, RAMIFICATIONS, AND SCOPE

Accordingly, the reader of this patent application will see the improvements achieved with the utilization of dual action mechanisms as presented in the ‘Detailed Description.’ It will conclude, with the reader visualizing the action: A rodent or other small animal, traveling in a generally straight line, going from point A to point B, along a familiar line of travel for rodents, triggering the first bait pedal it comes into contact with, not realizing that the bow is arcing over its body from behind, which, as with the domino effect, will inevitably trigger the release of the second bow, at or nearly simultaneously, through direct contact or mechanical vibrations, striking rodent from the front, ensuring take down while maintaining trap stability and permanence in placement.

Bait pedals, as utilized in the preferred embodiment of this invention, are economically manufactured, utilizing a single, presently manufactured, plastic, mold injection set up and an already developed snap-on fit with ease of adjustment assembly. Also, the enlarged area of the bait pedal along with its ability to provide adjustment in sensitivity of the trigger mechanism enhances overall versatility.

Bait pedals may also be designed in a possibly cheaper version, utilizing tried and true copper or other metal, also pivoting on a centrally located staple, opposing and facing each other, at the mid-line, with just enough lip area to precariously secure hold down rod in place. It will be utilized for engaging the hold down rod while in the vertical position but may also accommodate solid bait mounted on the extended prong while in the horizontal position.

It also may be of the known type that is copper and broad enough, curled over itself on one end, able to accommodate solid bait and yet also be sensitive enough to efficiently release the hold down rods through minimal contact from the main portion of bait pedals. This same action, with variations of materials used to mfg. bait pedals will no doubt release both spring-loaded bows with rodent contact and/or vibrations felt by same. Release of one bow after contact with rodent will produce enough energy to release second bow. In other words, this invention is not limited to only one, i.e. plastic bait pedal but to any bait pedal that is sufficiently able to precariously hold the hold down rod in place for ensured and improved operation thus improved kill rate and hence, increased rodent control.

Lastly, the overall size of the trap is not limited to one size only, strictly for rat control but may also be configured on a smaller baseboard, with the exact hardware, for the improved control of smaller rodents, i.e. mice. Bows, locking bars, tension springs, bait pedals would essentially be configured the same, dual and inline, on an elongated board, albeit on a smaller scale, 75% reduction in overall scale, that would justify it's use for small rodent control.

A preferred, but not limited to, embodiment of this invention will now be described by way of example only in reference to the accompanying drawings. 30-45 degree angles are

The embodiments of this invention in which and exclusive property or privilege is claimed are defined as follows:

1. An animal trap comprising:
A main body, having a top surface area, opposite sides and reduced; opposite ends with mounting holes in said main body for vertical positioning and stability wherein
Dual bait receiving means, disposed atop said upper surface of said main body; dual bow members mounted pivotally on a horizontal axis, disposed transversely to said main body portion, able to move freely in a 180 degree arc, in relation to its horizontal axis from a set to a sprung position with
Dual hold down rods pivotally mounted on opposing ends of said main body portion whereby maintaining free ends, able to engage engagement means of said bait receiving means.
Dual spring's means urging said bow members to a sprung position

2. I claim an improvement as stated in claim 1, utilizes a sufficiently elongated said main body, approximately doubling surface area thereby increasing it's own weight directly proportional to said body portion length, thereby improving overall stability and handling of said main body whereby

3. utilizing a 30-45 degree reduction of said opposite ends of said main body, as claimed in claim 2, for manipulation of rodent travel over and across said main body and

4. an improvement as stated in claim 1, wherein said bait pedals are doubled and disposed adjacent to each other whereby

5. said bait pedals, as mentioned in claim 4, are of size, shape, and placement, substantial enough to cover an area adjacent to the midline, the centerline area of the trap approximately surrounded by said bow members in the sprung position whereby

6. said bow members as mentioned in claim 5 are also doubled, opposing and facing each other, on dual, pivoting axis supplied by permanent means, on outer edges of said main body and

7. said hold down rods, as stated in claim 1, wherein are also doubled and inline, each individually mounted on opposite sides of said base, on pivotal mounting points, maintaining free, angled ends, pointing towards centerline while maintaining said bows in the armed position whereby

8. contact with said bait receiving means, as mentioned in claims 4 and 5, releases said hold down rod means, allowing said tension springs means to urge said bow member to arc towards the centerline, in a horizontal, 180 degree line of travel whereby

9. mechanical contact with said second bait receiving means as claimed in claim 8 or transfer of energy created by contact of first said bow member means allows release of second said hold down rod means via movement of second bait receiving means, urging second bow member means to centerline at or near simultaneously and

10. an additional improvement, as claimed in claim 8, wherein said tension springs means are also doubled, able to, at or near simultaneously, urge dual said bow members from the set position to the sprung position wherein also

11. providing four holes, each drilled in the main planar body portion of said main body means, as stated in claim 2, a single hole in each corner of said main body means, whereby supplying attachment means in the vertical or horizontal position
